(19) United States
(12) Patent Application Publication
(10) Pub. No.: US 2003/0043271 A1
(43) Pub. Date: Mar. 6, 2003

(54) Computer interface system and method

(75) Inventor: Nehal R. Dantwala, Peekskill, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/945,957

(22) Filed: Sep. 4, 2001

(51) Int. Cl. H04N 5/222; H04N 7/00; H04N 11/00

(52) U.S. Cl. 348/207.1; 348/552; 348/211.11; 348/211.5; 348/222.1; 348/333.01

(57) ABSTRACT

A system for interfacing with a computer using visual cues, and a method of performing visual-cue operation. In a computer system having a central processing unit (CPU), and memory, a data-storage device, and an interface for receiving, interpreting and executing commands formulated by a user, a camera is positioned to allow the user to enter its visual field. To remotely operate the computer, the user performs a predetermined motion or series of motions while in the camera's field of view. The camera captures an image of the user and digitized the image into a video data stream. A video processor monitors the video data stream for indications that the user has entered a visual cue by performing a prescribed motion. When a visual cue is recognized, the video processor then generates a command set corresponding to the recognized cue. The command set then presented to the computer's command processor for execution. Ease of use for the visual cue interface is enhanced by using the computer's graphical display to superimpose a command template over the image of the user being captured by the camera.

### TECHNICAL FIELD OF THE INVENTION

The present invention is directed, in general, to remote interface devices for use with computers and, more specifically, to a system and method for enabling a user to remotely interface with a computer using visual cues.

### BACKGROUND OF THE INVENTION

In the course of only a few decades, computers have gone from sophisticated, bulky electronic machines used only by government agencies and academic institutions, to become popular, compact, and affordable devices for use in one way or another by nearly everyone. Even individuals not extensively versed in computer operations now expect to be able to perform many tasks with only minimal instruction. One reason for their popularity is that the computers of today have become far easier to operate with than were their predecessors of the not so distant past.

Originally quite difficult for individuals to master without a substantial amount of training, commands, that is, instructions to the computer, have now become relatively simple. One reason for this ease is that commands are now designed to be more similar to language as it is naturally used, rather than a memorized set of esoteric, and often cryptic, set of abbreviations and symbols understood only by educated professionals. Computer commands, in fact, have evolved from the mere use of words, symbols, or abbreviations to the manipulation of visual devices on the screen, which offer assistance to the user attempting to perform a given operation. For example, a user wishing to begin a new project may simply type in a few easily memorable keystrokes, and then be provided with a series of visual inquiries directing them through the appropriate set up process. In other words, the user no longer has to be as explicit and precise as would have been required with past systems, but can simply let the computer know in a natural way the operation to be performed, the computer having been appropriately programmed in advance to respond to such a request.

Input devices, the electromechanical means for communicating with a computer, have also become easier to use. The laborious task of preparing punch cards or magnetic tapes, and the use of a teletype machine for communication have now been replaced by a variety of modern input devices. Not surprisingly, one of the first such devices was a set of keys fashioned in the style of a typewriter keyboard. Computer keyboards provide the user with a plurality of switches labeled with symbols representing letters and other characters. When an individual key is struck, either alone or in combination with other keys, a unique electrical signal is returned to the computer's keyboard interface circuitry where it is interpreted appropriately. Through the keyboard device, a human user inputs commands and data for the computer to act upon. The results of the user's instructions manifest themselves in a variety of ways, but most usually by the appearance on a visual display of either the command, instructions, or data itself, or of the results of a requested computation.

To make user input even faster and easier, a device called a “mouse” was developed. A mouse is a device connected to the computer that is capable of translating movement induced upon it by a user into a series of electrical signals interpretable by the computer's mouse interface. The mouse is almost invariably coupled with a graphical pointing device, such as an arrow, that is visible on the user's graphical display, which is often referred to as a monitor. In order to provide instructions to the computer, the user simply manipulates the position of the mouse, which in turn sends information to the computer causing the pointing device to move about on the visual display. The user manipulates the pointer in this way until it is in the appropriate location and then signals the computer that the command located at that location is the one that the user wishes to activate. The user will normally do this by pressing a button (often called “clicking”) or perhaps depressing a particular key or combination of keys on the keyboard.

A software program resident on the computer is capable of interfacing with the mouse so that the computer can translate the positional coordinates of the pointing device on the visual display into the appropriate command. Note that the mouse is often used in conjunction with, rather than completely replacing, the traditional computer keyboard. Most computer users today are adapted to using a mouse and keyboard in combination; while either one or the other might be sufficient, most will simply use whichever device is most convenient for the particular operation which they are trying to perform at any given time.

Other common user interface devices include joysticks, steering wheels, and foot pedals, which are often used to direct a visual object that is moving on the user's visual display. These devices mimic analogous control devices found in airplanes, automobiles, or other vehicles. The use of these devices is not limited to computer programs simulating vehicle motion, however, as they can also be used for moving a variety of visual objects around the display screen in response to appropriate user manipulation.

Traditionally connected to the computer via cables, these interface devices are also capable of transmitting input to the computer via a wireless radio connection or infrared signal. These wireless devices provide the convenience of being able to relocate the interface device without the constraints of a physical wire, which not only imposes a distance limitation but can become disconnected or get in the user's way while being moved around.

While these wireless interface devices in some sense provide “remote” operation of the computer, that is, operation without a physical connection, they still rely basically on traditional methods of computer interface, keyboards, mice, joysticks and the like. And, of course, the user must remain in physical contact with the input device itself. In many cases, it would therefore be advantageous to employ a truly remote way of communicating with a computing device without the need for traditional interface apparatus. The present invention provides just such a system and method.

### SUMMARY OF THE INVENTION

It is an object of the present invention to provide a system, and a related method, for enabling remote user interface with a computing device.

In one aspect, the present invention is a system for interfacing with a computer that includes an image-capturing device and an image-digitizing device connected to the image-capturing device for digitizing all or a portion of the image for transmission to the computer. The system further includes a connecting means, either physical or electromagnetic, for transmission of the digitized signal to the computer. The system further includes software resident on the computer for interpreting the digitized image received from the digitizer. The system may also include a video display for demonstrating to the user the results of various commands and requests.

In another aspect, the present invention is a method of providing remote interface to a computing device including the steps of providing an image-capturing device accessible by a user, providing an image-digitizing device connected to the image-capturing device and to the computer, such that captured images can be digitized and transmitted to the computer for interpretation.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,”, “processor,” or “apparatus” means any device, system, or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a personal computer system typical of one that may be configured in accordance with an embodiment of the present invention;

FIG. 2 is a schematic diagram illustrating the interconnection between selected components of the personal computer system of FIG. 1 in accordance with an embodiment of the present invention;

FIG. 3 is a schematic diagram illustrating the interconnection between various selected components configured in accordance with a multi-camera embodiment of the present invention;

FIG. 4 is an illustration depicting a sample display screen displaying a template in accordance with an embodiment of the present invention;

FIG. 5 is a flow chart illustrating a method for operation of a computer using visual cues according to an embodiment of the present invention; and

FIG. 6 is a flow chart illustrating a method for recognizing visual cues according to an embodiment of the present invention.

### DETAILED DESCRIPTION OF THE INVENTION

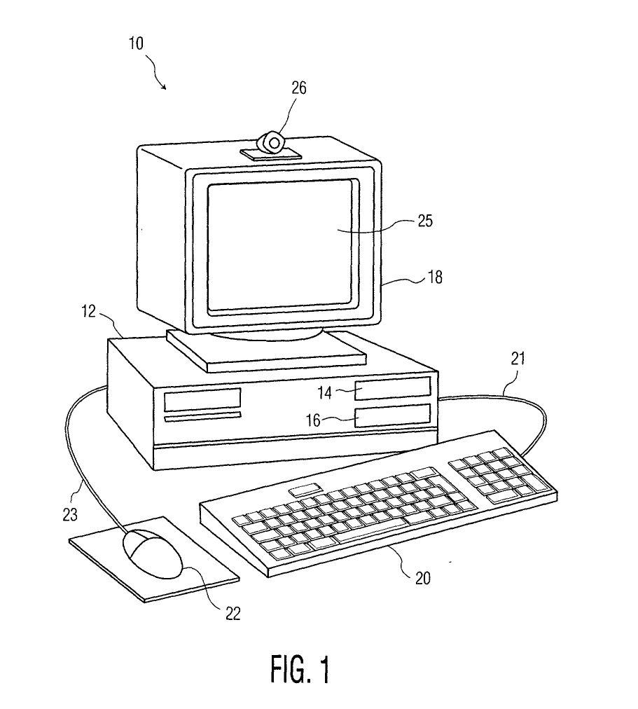

FIGS. 1 through 6, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a personal computer and related peripheral devices. Those skilled in the art will recognize that the exemplary embodiment of the present invention may easily be modified for use in other similar types of systems for interfacing with a computing system.

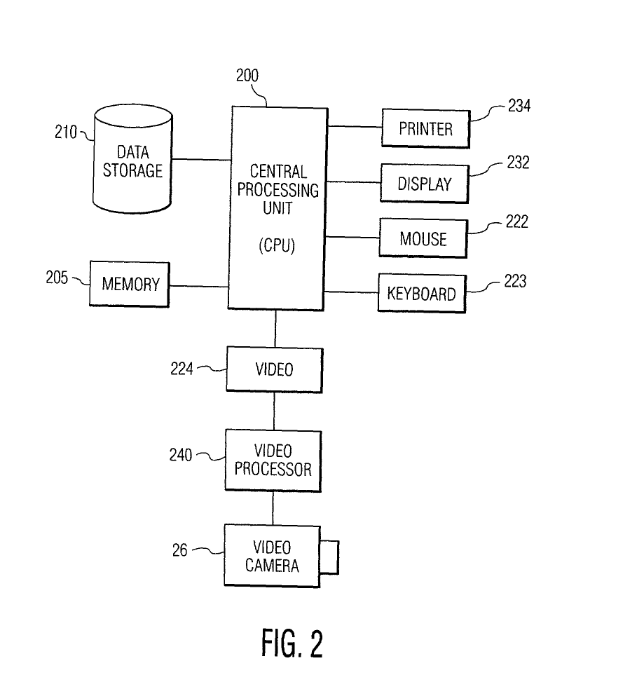

FIG. 1 is an illustration of a personal computer 10 such as one that may be used in conjunction with an embodiment of the present invention. Inside the computer housing 12 are, among other components, a central processing unit (CPU), a memory register, and one or more data-storage devices (see FIG. 2). The memory register, in general, is an electronic storage device for temporarily storing various instruction and data concerned with operations the computer is currently processing. The data-storage devices are used for storing data and instructions on a longer-term basis, including periods when power to the computer is off, and hold far more information than can be kept in memory. In the embodiment illustrated in FIG. 1, the data storage devices include a hard-disk drive (not shown), a floppy-disk drive 14 and a compact-disk drive 16. The latter two drives use removable storage media, which increases storage capacity indefinitely and provides one way of introducing new programs and data into the computer 10.

The computer 10 depicted in FIG. 1 also features the keyboard 20 and mouse 22 user-input devices, which are connected to computer 10 via cables 21 and 23, respectively. Positioned atop computer housing 12 is a monitor 18 having graphics display screen 25, on which the user can view the status of operations being conducted by computer 10. Positioned atop of the monitor 18 is a video camera 26 directed so as to be generally pointing at the user who is operating personal computer 10. The camera 26 is also connected to computer 10 via a cable (not shown) and may be used for any number of applications such as video-conferencing or simply as a picture-taking device. As used herein, a camera is a device that captures a visual image and digitizes it into a video stream, or series of digital signals for later processing. In accordance with the present invention, the image-capturing device and the image-digitizing device could also be separate components.

Note that while FIG. 1 illustrates a typical personal computer configuration, the present invention may be used with other kinds of computer systems as well. In addition, it should be noted that the mouse 22 and keyboard 20 depicted in FIG. 1 are optional components that are not necessary, however desirable, to the function of the present invention.

Likewise, the monitor 18 and camera 26 may be positioned differently, and do not have to be located adjacent one another. In addition, there may be more than one camera or other image-capturing device available for video input. Note also that in many applications involving the present invention, there may be a physically separate video-processing unit associated with the visual-cue input system. This configuration would be particularly advantageous in the case where a number of video cameras are employed, as more fully described below.

FIG. 2 is a schematic diagram illustrating the functional interconnection of selected components of the personal computer 10 of FIG. 1. CPU 200 is the heart of the personal computer, and is in communication with memory 205 and data storage device 210. The CPU 200 is capable of executing commands, that is, instructions delivered to it in the proper format. Any input device, however, produces electrical signals in its own format that must be translated into one that is understandable to the CPU. This task is accomplished by interfaces such as mouse interface 222, keyboard interface 223, and video interface 224.

Similarly, output interfaces such as graphical display (monitor) interface 232 and printer interface 234. (Output interfaces are often called “drivers”.) Note that these various interface components shown in FIG. 2 are functional, that is, there is no requirement that they are physically separate devices, but instead include whatever combination of hardware and software needed to allow disparate input/output devices to communicate with the CPU 200. The same is true of video processor 240, shown here associated with its own video interface 224. In one embodiment, video processor 240 also includes its own dedicated memory register and data storage (not shown). These components, however, may also be appropriate software that simply shares the computer's own CPU, memory, and data storage. The function of video processor 240 is to monitor the video input received from the cameras, recognize visual cues, and generate command sets, as described more fully below.

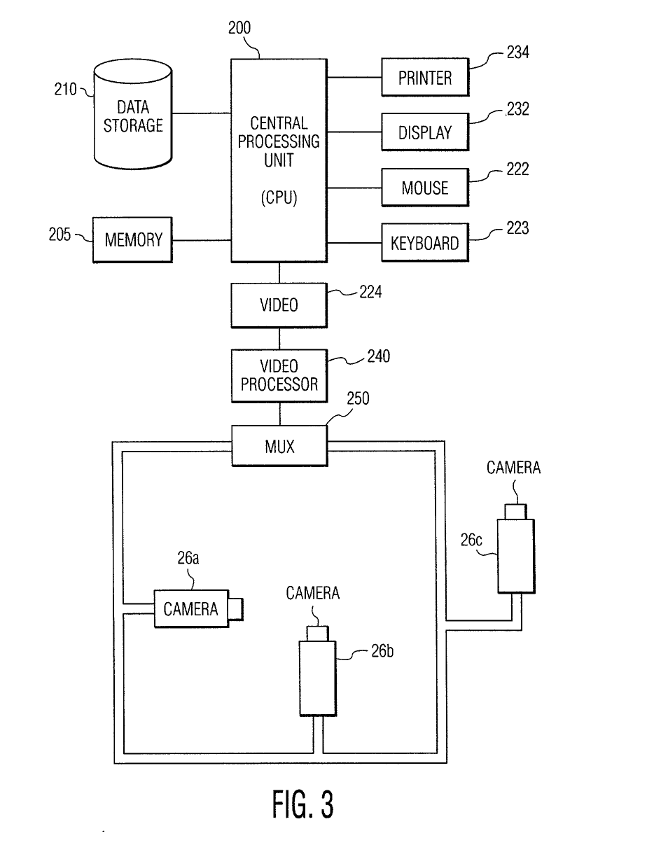

FIG. 3 is a simplified schematic diagram showing the interconnection of various components in accordance with a multi-camera embodiment of the present invention. Multiple cameras are not required, but may be preferred in certain applications. For example, in a large room the user may wish to input visual cues from a variety of locations, and may even wish to move from one area of the room to another before a given computer operation has been completed. In the illustrated embodiment, cameras 26a, 26b, and 26c are placed so as to be able to capture video images from different fields of view. The cameras transmit video data to multiplexer 250, where it is combined into a single video stream and provided to video processor 240. In an alternate embodiment, video processor 240 and multiplexer 250 are combined into a single unit. Note that the multiplexed signal may also be used for other applications, such as video conferencing.

In either embodiment, video processor 240 is capable of monitoring the video inputs from more than one camera in case a visual cue is received at any one of them. It may also perform the function of determining the origin of a recognized visual cue so that, when appropriate, it can direct the function of multiplexer 250 to adjust the ratios in which signals from cameras 26a, 26b, and 26c are combined. In another embodiment, each video camera contains a timing function that can be synchronized so that each sends an image to the video processor 240 in turn, and in this case the video streams may not be multiplexed at all. Finally, note that there are numerous ways of connecting multiple cameras, and the embodiment of FIG. 3 is simply one example.

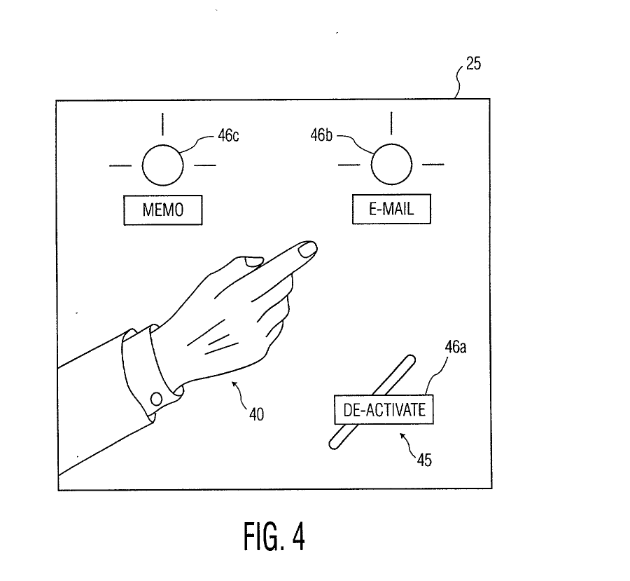

FIG. 4 is an illustration depicting a sample display screen in accordance with an embodiment of the present invention. In a preferred embodiment, screen 25 (also appearing on monitor 18 shown in FIG. 1) displays the image 40 being captured by camera 26. This image 40 may be continuously displayed, or may appear only when the visual cue-system has been activated. In a multi-camera system, such as the one represented in FIG. 3, the screen may cycle between the images captured by the various cameras until the video processor perceives that a visual cue is being entered through one of them. Superimposed with the captured image 40 is a template 45 generated by the video processor 240 (not shown in FIG. 4). The template 45 contains visual elements 46a, 46b, and 46c to guide the user in executing proper visual cues. The user simply watches the screen, for example, and moves a hand until it coincides with the location of a visual element of the template 45. While not a requirement for practicing the present invention, template 40 permits the convenient use of more sophisticated visual cues. Naturally, template 45 will change appropriately as the computing operation progresses, and in a preferred embodiment may be customized for each individual user.

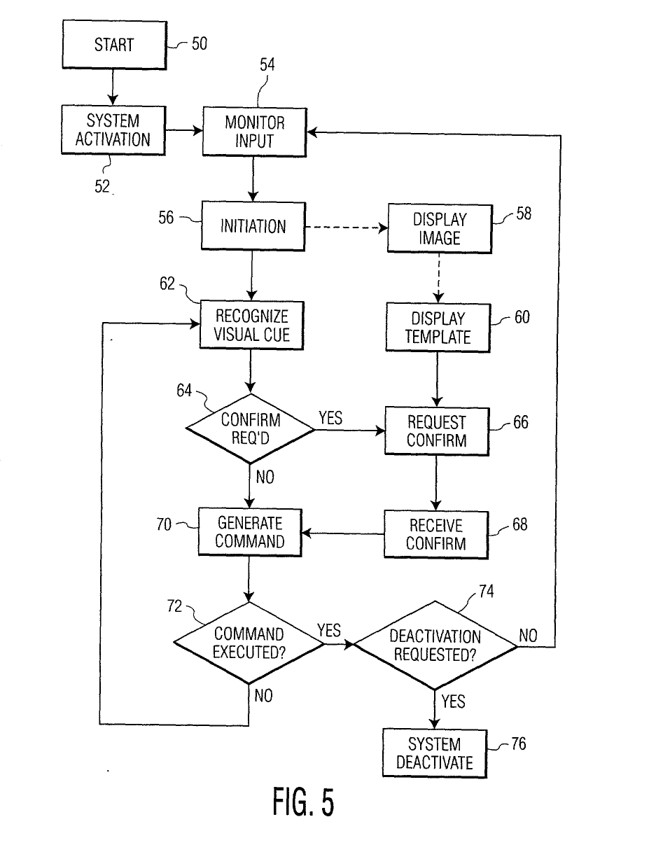

FIG. 5 is a flowchart illustrating an embodiment of the method of the present invention for remote operation of a computer. At Start 50, hardware and software utilized for practicing the invention, described above, has been installed. In other words, the personal computer or other computing device is configured for remote operation through visual cues in accordance with the present invention.

At step 52 the interface is activated, that is, made ready to receive a user input. Note that in some cases it may be desirable to allow the interface to remain activated continuously while in others, selective activation may be more desirable (for example, where the opportunity for spurious inputs is high). In the former instance, the interface may be activated whenever the computer is booted up. In the latter, activation may be accomplished using whatever other interface devices are available, including keyboard or mouse manipulation, or a recognizable voice command. Whatever device is used, however, once activated the system is ready for remote operation using visual cues.

It may be some time, of course, before such a cue is entered, but once activated, video inputs to the system (that is, video processor 240) are continuously monitored (step 54) until an initiation signal is received (step 56). The initiation signal is a predetermined visual cue that, when performed by the user, results in a video signal appearing to match one stored in the baseline database by the video processor 240. As the video camera receives and digitizes video inputs continuously, the visual cue must be defined sufficiently to permit it to be reliably distinguished from shifting background movements, shadows, etc. The user may be required, for example, to wave a hand rapidly in view of the video camera in order to initiate the system.

Once initiated in step 56, the interface system is prepared to receive one or more (additional) visual cues to be formed into commands for the computer to process. In a preferred embodiment, once initiation has occurred the system causes a visual cue template to appear on the computer's graphical display device, step 58. The template may be designed in a wide variety of different ways, but to the user should appear to delineate on the display screen distinct areas. (See, for example, the exemplary template 40 of FIG. 4.) The template is superimposed onto the image being viewed by the camera. In this way the user can more easily execute the proper visual cues, for example holding a hand in position in front of the camera so that it appears on the screen to be covering a graphical user interface labeled “email”.

Note that while the template is advantageous, it is not necessary where the user simply knows at which location on the display screen to position a hand. In an alternate embodiment, the user simply holds a hand, for example, so that it appears in the upper right-hand corner of the display screen. In this embodiment, the template does not appear automatically but is preferably available to be invoked by a user that is, for example, positioning the camera or calibrating the interface, or by one who is experiencing difficulty executing the proper visual cues.

By the same token, initiation step 56 may not be required. The user, for instance, may not even be positioned to view the display screen, but simply know that a hand placed generally to the right while sitting in front of the camera will cause the computer to perform a certain function. This may be useful, for example, where the same graphical display device is being used both as a computer monitor and as a motion picture display screen. A user seated two or three meters from the display could cause it to switch back and forth between the two functions. Or, the user may indicate by visual cues, such as pointing left or right, which way on the display screen a moving figure or point of reference should ‘look’ or turn. Again, however, where initiation is not a separate step, it is preferable to have some mechanism available to a user wishing to confirm that the system is ready to receive a visual cue (e.g., a “ready light” indicator).

A visual cue is any predetermined user action that can be captured as an image by the camera, such as waiving a hand, holding a hand motionless in a particular spot, or simply standing in view of the camera. The visual cues may executed by the user may be used to start, stop, or operate any function the computer is otherwise capable of performing. The visual-cue interface may also be used to operate or adjust the interface system itself, for instance turning it one and off, re-aiming the camera if it can be remotely aimed, or changing the visual-cue templates, if there are more than one available. Most likely, the visual-cue interface will be used in conjunction with other input interfaces, especially one also capable of operating at a distance such as voice recognition.

When the video processor receives a video signal corresponding to a visual cue that it recognizes (step 62), it determines whether an explicit user confirmation is required (step 64). This requirement may be the result of system customization by the user, or may be a default requirement for certain commands, such as deactivation. For example, a user who holds a hand in the captured-image field corresponding to “retrieve email” would be asked, either through the video display or through an audio (prerecorded or synthesized) query, to respond affirmatively if execution of this command is desired. At that point the user may respond by using a hand signal or as may be otherwise appropriate depending on the input devices available. In an alternate embodiment (not shown), implicit confirmation may suffice. That is, the user may be in some way notified that the requested command will be executed, but given the opportunity to cancel a command by visual cue or simply by saying “no”. Failing to cancel the command in the prescribed time period is considered implicit confirmation.

When confirmation is received (step 68), or if it is not required, the video processor generates a command set corresponding to the recognized visual cue (step 70). A command set is simply a set of one or more instructions for executing the desired computer operation that is understandable to the CPU's command processor. It may be a single command or a collection of several commands (sometimes referred to as a “macro”), as may be necessary to perform the operation requested by the user through the visual cue. Preferably, as soon as it is generated, the command set is made available for execution by the CPU, which ordinarily will process it in turn. Any error messages will be returned to the user in the usual fashion, as will any requests for additional data or instructions appropriate to the operation being performed. In a preferred embodiment, the CPU will notify the video processor that that command has been executed, or that it requires more information or further instructions.

If the video processor determines, at step 72, that the command set has not been executed, the process returns to step 62 to receive additional input. If the command set has been properly executed, the video processor then determines if deactivation is appropriate (step 74). If not, the process returns to step 54 and continues monitoring the video stream for further input. If, on the other hand, deactivation has been requested, either explicitly by the user or as the result of a default setting to deactivate after a certain operation, the system proceed to shut down (step 76) until reactivated. Note that the determination step 74 may include a predetermined time delay during which the user may enter an explicit deactivation instruction, or the system may query the user to make the determination. Or the user may effect a negative determination simply by entering another visual cue.

Whether the visual cue interface is regularly activated and deactivated is largely a question of user choice, or whether the computer system is designed for a specific purpose. In practice, some remain on most of the time, while others are turned on only when needed. In this regard note that since the present invention requires video input for initiation, it would also usually be required that the computer system be powered up at the start of this process. One exception would be where the video processor is housed outside of the main computing unit as a separate device. In this instance, it may be desirable to include in the video processing unit a facility for powering-up the computer if the visual-cue interface of the present invention is activated (step not shown).

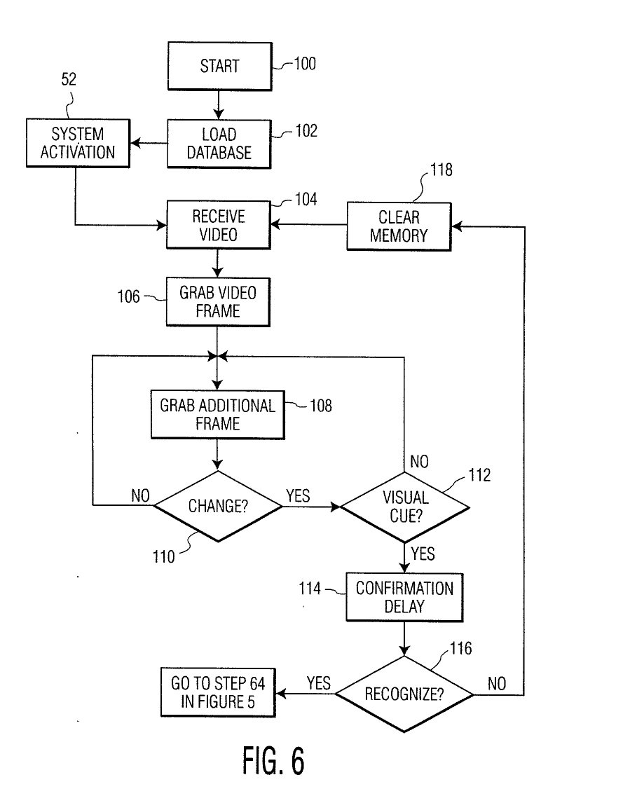

FIG. 6 is a flow chart illustrating a method for recognition of visual cues according to an embodiment of the present invention. Note that FIG. 6 follows generally from the method outlined in FIG. 5, but focuses specifically on the video processor 240 the recognition step (step 52 in FIG. 5). Turning to FIG. 6, at start 100, it is again assumed that the appropriate hardware and software have been installed for the video cue system to operate. Before recognition can take place, however, the visual cue baseline information must be loaded onto the system database (step 102). This information consists of data describing the various visual cues that will be recognized by the system and the computer operation with which each visual cue is associated. Although basic baseline information may be present in the visual-cue operating software, it is generally preferred that users be allowed to customize the cues to their own specific requirements. In addition, where a consistent background exists against which the visual cues will be executed, information about it may be added to the database as well, to better enable the system to filter out spurious inputs.

Once this information is loaded, the visual-cue interface can be activated (step 52, also shown in FIG. 5). The video processor 240 is, accordingly, receiving video input. As mentioned previously, this input may originate from a single camera, from multiple cameras sending video signals in turn, or from a multiplexer that itself receives input from multiple cameras. As it receives the video stream (step 104), the video processor grabs and stores a frame of video in memory (step 106). Frame, as used here, means a portion of the video stream from a given camera corresponding to a single complete picture, or ‘snapshot’ of the image being captured. Again, the memory register may be that of the personal computer 10, or may be a separate component dedicated to this purpose. In a multi-camera environment, the video processor repeats this process for each camera being monitored, storing each frame so that its origin can be identified. After a predetermined period of time, an additional frame is grabbed and stored (step 108). The stored frames are then compared to see if a substantial level of change from the first to the second can be observed (step 110). If not, the process reiterates indefinitely until a change it noted. Note, however, that only a finite number frames will be retained in memory, and then this preset limit has been reached, the oldest frame is discarded each time a new frame is grabbed and stored (step not shown).

If a change is noted at step 110, however, the stored frames are compared to the baseline information in the database to see if a visual cue has been or is being entered (step 112). If not, the process returns to step 108, where additional frames are grabbed, stored, and compared those previously obtained. If a potential visual clue is identified as being entered, the process instead proceeds to confirmation step 114. This step is distinct from, and preferably occurs before, the confirmation process referred to beginning at step 64 of FIG. 5. Here, in step 114, confirmation refers to the process of grabbing and comparing additional frames of video after a possible visual cue has been identified. The results of these additional comparisons are used to filter out erroneous indication of a visual cue. For a visual cue to be recognized, the user is preferably required to hold the position of a static (stationary) cue for a predetermined period of time, such as 1 to 3 seconds, and to repeat dynamic (moving) cues a certain number of times in a given period. While the video processor may note the cues initially, the confirmation step will result in the rejection of those that are not held or repeated as required. The confirmation step 114 will result therefore result in a short, but probably unnoticeable delay. The video processor then makes a determination whether to recognize or reject the visual clue (step 116), based on the results obtained in the confirmation step 114. If not, in the illustrated embodiment, the process proceeds to clearing the memory (of frames from that camera), and begins again at step 104. If a visual cue is recognized at step 116, the process of FIG. 5 continues, beginning at step 64.

Note that the same process described above is applicable to the multi-camera embodiment, except that the video frames are grabbed for each camera in turn, and, of course, the frame comparison steps are performed in relation to other frames from that particular camera. Also, if a potential visual clue is identified (in step 12 of FIG. 6), the video processor 240 may instruct the multiplexer 250 to temporarily suspend input from other cameras, or to adjust the way in which the various inputs are combined so as to include a greater percentage of input from the camera of origin.

While the present invention has been described in detail with respect to certain embodiments thereof, those skilled in the art should understand that they can make various changes, substitutions modifications, alterations, and adaptations in the present invention without departing from the concept and scope of the invention in its broadest form.

What is claimed is:

1. A system capable of remotely interfacing with a computer using visual cues, said system comprising:
a video camera capable of capturing an image and converting the captured image into a video data stream; and
a video processor in communication with the video camera, wherein the video processor is capable of recognizing at least one visual cue, and in response to recognizing a visual cue, generating a computer command set and presenting the computer command set to the computer for execution.

2. The system as claimed in claim 1, further comprising:
a graphical display device in communication with the video processor through a graphical display interface module for selectively displaying an image captured by the video camera.

3. The system as claimed in claim 2 wherein the video processor is further capable of generating a visual cue command template for display on the graphical display device.

4. The system as claimed in claim 2 wherein the system is capable of displaying a captured image on the graphical display device.

5. The system as claimed in claim 1 wherein the system further comprises:
a plurality of video cameras; and
a multiplexer in communication with each of said plurality of video cameras and in communication with the video processor;
wherein the video processor is capable of processing a multiplexed video data stream from the multiplexer.

6. The system as claimed in claim 5 wherein the video processor is capable of directing the multiplexer to include in the video stream video data corresponding only to a selected camera.

7. A method of interfacing with a computer using visual cues, the method comprising the steps of:
providing a video camera for capturing and digitizing video images into a video data stream;
providing a video processor in communication with the video camera for receiving the digitized video data stream;
recognizing in the video processor that a visual cue has been executed; and
generating in the video processor a command set corresponding to the recognized visual cue for presentation to the computer.

8. The method of interfacing with a computer using visual cues as claimed in claim 7 wherein the step of recognizing in the video processor that a visual cue has been executed further comprises the steps of:
storing visual cue information in a database in communication with the video processor;
grabbing selected portions of the video data stream;
storing the grabbed selected portions of the video data stream; and
comparing the stored portions of the video data stream with visual cue information stored in the database to determine if a visual cue has been executed by the user.

9. The method of interfacing with a computer using visual cues as claimed in claim 7, further comprising the step of generating a user-confirmation query.

10. The method of interfacing with a computer using visual cues as claimed in claim 9, wherein the step of generating in the video processor a command set for presentation to the computer is not completed until an affirmative response to a user confirmation query is received.

11. The method of interfacing with a computer using visual cues as claimed in claim 10, wherein the affirmative response is an explicit affirmative response.

12. The method of interfacing with a computer using visual cues as claimed in claim 7, wherein the method further comprises the step of generating a visual cue template.

13. The method of interfacing with a computer using visual cues as claimed in claim 7, wherein the method further comprises the step displaying the visual cue template on a monitor that is connected to the computer.

14. The method of interfacing with a computer using visual cues as claimed in claim 7, wherein the method further comprises the step of displaying an image that is being captured by the video camera on a monitor that is connected to the computer.

15. The method of interfacing with a computer using visual cues as claimed in claim 7, wherein the step of providing a video camera for capturing and digitizing video images into a video data stream includes the step of:
providing a plurality of video cameras; and
providing a video processor that is capable of processing video data from the plurality of video cameras.

16. A video processor for detecting visual cues executed by a user for remote operation of a computer system comprising a central processing unit, a graphical display device, and at least one video camera, wherein said video processor is capable of:
receiving video data from said at least one video camera;
recognizing when video data contains information corresponding to a visual cue; and
generating a command set corresponding to a visual cue.

17. The video processor as claimed in claim 16, wherein said video processor is capable of generating a visual cue template for display on the graphical display device.

18. The video processor as claimed in claim 17, wherein said video processor generates the template only after receiving a user request to do so.

19. The video processor as claimed in claim 16, wherein the computer system includes a plurality of video cameras and a multiplexer, and said video processor is capable of monitoring a multiplexed video data stream.

20. The video processor as claimed in claim 19, wherein said video processor is capable of determining which video camera received a recognized visual cue.

21. The video processor as claimed in claim 20, wherein said video processor is capable of sending control commands to the multiplexer.

22. The video processor as claimed in claim 16, wherein said video processor is capable of generating a user confirmation query.

23. The video processor as claimed in claim 22, wherein the command set is not generated until an affirmative confirmation to a confirmation query has been received.

24. The video processor as claimed in claim 23, wherein the command set is not generated until an explicit affirmative confirmation request is received.

25. The video processor as claimed in claim 16, wherein said video processor recognizes visual cues by:
grabbing selected frames of video from the video data at predetermined intervals;
storing the grabbed frames of video from the video data; and
comparing the stored frames of video to determine if there has been a change from one interval to another in an image captured by the video camera.

26. The video processor as claimed in claim 25, wherein said video processor is further capable of determining if a change in a captured image corresponds to a visual cue.
